(19) United States
(12) Patent Application Publication
(10) Pub. No.: US 2015/0098236 A1
(43) Pub. Date: Apr. 9, 2015

(54) OPTICAL STRUCTURE FOR HEADLIGHT

(71) Applicant: TYC BROTHER INDUSTRIAL CO., LTD., Tainan (TW)

(72) Inventors: MIN-FENG LIN, TAINAN (TW); MING-JHIH SHIH, TAINAN (TW); JIN-HUA WU, TAINAN (TW)

(73) Assignee: TYC BROTHER INDUSTRIAL CO., LTD., Tainan (TW)

(21) Appl. No.: 14/046,008

(22) Filed: Oct. 4, 2013

(51) Int. Cl. F21S 8/10

(52) U.S. Cl. CPC F21S 48/1388; F21W 2101/10
USPC 362/517

(57) ABSTRACT

A headlight includes a main reflective member having an oval reflective surface which has a first focal point and a second focal point. A light source is located at the first focal point of the main reflective member. At least one additional reflector is located on one side of the main reflective member, wherein the light source is located between the main reflective member and the additional reflector. The at least one additional reflector has a curved reflective surface which has a third focal point located close to the first focal point. The light beams generated from the light source are reflected by the at least one additional reflector and pass through the third focal point and the main reflective member and move forward. The tracks of the light beams are close to that of light beams that are directly reflected by the main reflective member.

### FIELD OF THE INVENTION

The present invention relates to a headlight optical structure, and more particularly, to a headlight having a main reflective member and an additional reflector to guide the light tracks to be focused at a position close to the light source.

### BACKGROUND OF THE INVENTION

The conventional projector type headlight utilizes an oval reflection surface of the headlight to guide the light beams. The oval reflection surface has a first focal point and a second focal point. LEDs are located at the first focal point and the light beams are reflected by the oval reflection surface and focused at the second focal point, and then passes through the lens. The LEDs are inserted to the headlight in the direction the same as the light beams passing through the lens so that the headlight needs sufficient depth to accommodate the LEDs.

U.S. Pat. No. 7,093,966 discloses a “Vehicle Headlamp” as shown in FIGS. 1 and 2, the headlamp comprises a base 10 having a light source 101 installed therein and an optical axis Aₓ is perpendicular to the installation direction of the light source 101. The lens 20 is located on the optical axis Aₓ. A rear reflector 102 is located at the other end of the base 10 and opposite to the lens 20.

The light source 101 is located below the optical axis Aₓ, and a first additional reflector 103 is located between the light source 101 and the lens 20 so that the light beams generated from the light source 101 pass through the lens 20.

A second additional reflector 104 is installed in front of the light source 101 so as to reflect the light beams reflected from the first additional reflector 103, and the light beams are reflected toward the optical axis Aₓ.

Due to the installation of the light source 101, the light beams that go forward relative to the light source 101 cannot pass through the lens 20 via the rear reflector 102. In other words, the lamination is in-effective and the energy wastes. Therefore, by using the first additional reflector 103, cooperated with the second additional reflector 104 located at the front of the light source 101, the light beams that move toward the lens 20 will be reflected by the first additional reflector 103 and then reflected by the second additional reflector 104 or the rear reflector 102, so as to be effectively guided to go through the lens 20.

However, a portion of the light beams generated from the light source 101 of the conventional headlamp are directly reflected by the rear reflector 102 and then pass through the lens 20. The rest portion of the light beams moves toward and are reflected by the first additional reflector 103, and then reflected by the rear reflector 102. Because the optical surface of the rear reflector 102 is designed according to the position of the light source 101, the light beams reflected by the first additional reflector 103 and reaching to the rear reflector 102 do not meet the requirements of the optical design of the rear reflector 102. The tracks of the light beams that are directly reflected by the rear reflector 102 and the tracks of the light beams that are first reflected by the first additional reflector 103 have significant difference. The final luminous distribution pattern that is supposed to meet the regulations is affected. It is obvious that a lot of design concerns are involved when installing the first and second additional reflectors 103, 104. The problems caused by the two luminous distribution patterns also increase the time needed when designing the optical structure, and the manufacturing cost is increased.

The present invention intends to provide a headlight which improves the shortcomings mentioned above.

### SUMMARY OF THE INVENTION

The present invention relates to a headlight and comprises a main reflective member having an oval reflective surface which has a first focal point and a second focal point. A light source is located at the first focal point of the main reflective member. At least one additional reflector is located on one side of the main reflective member, wherein the light source is located between the main reflective member and the additional reflector. The at least one additional reflector has a curved reflective surface which has a third focal point located close to the first focal point.

Preferably, the third focal point is located within an area of four times of a radius of the light source.

Preferably, the third focal point is located within an area of two times of a radius of the light source.

Preferably, the third focal point is located on a periphery of a radius of the light source.

Preferably, the curved reflective surface is a spherical surface.

Preferably, the curved reflective surface is a non-spherical surface.

Preferably, the headlight further comprises a base that accommodates the main reflective member and the light source. A lens is connected to the base and located on an optical axis of the light source.

Preferably, a shade is located between the main reflective member and the lens.

The present invention improves the shortcoming of the need of a deep headlight case. Besides, the conventional headlight have the first and second additional reflectors, and the optical surface of the rear reflector is designed according to the position of the light source, so that the light beams reflected by the first additional reflector or the rear reflector have different tracks which affect the required luminous distribution pattern. Furthermore, the need of the first and second additional reflectors includes the manufacturing cost.

Compared with the conventional headlight, the present invention comprises the main reflective member and the additional reflector so as to guide the light beams to be reflected by the additional reflector and are focused at a position close to the light source. In other words, the light beams reflected by the additional reflector are focused at the periphery of the light source. The tracks of the light beams are close to that of the light beams directly reflected by the main reflective member. Therefore, the depth of the headlight case can be shortened and the time for designing the optical design is reduced.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show the conventional headlight;

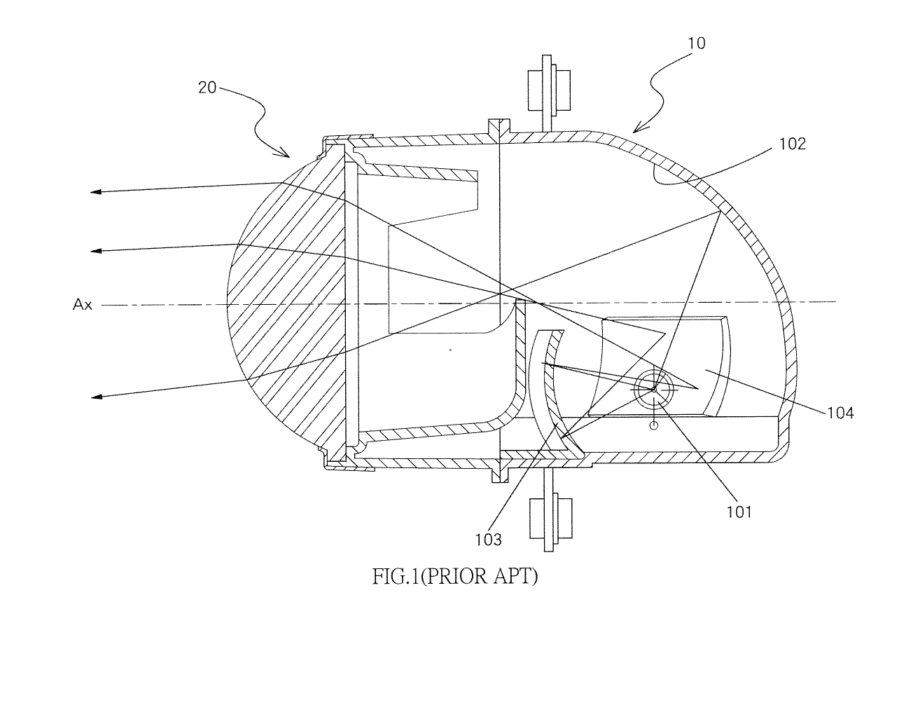

FIG. 2 is another cross sectional view to show the conventional headlight;

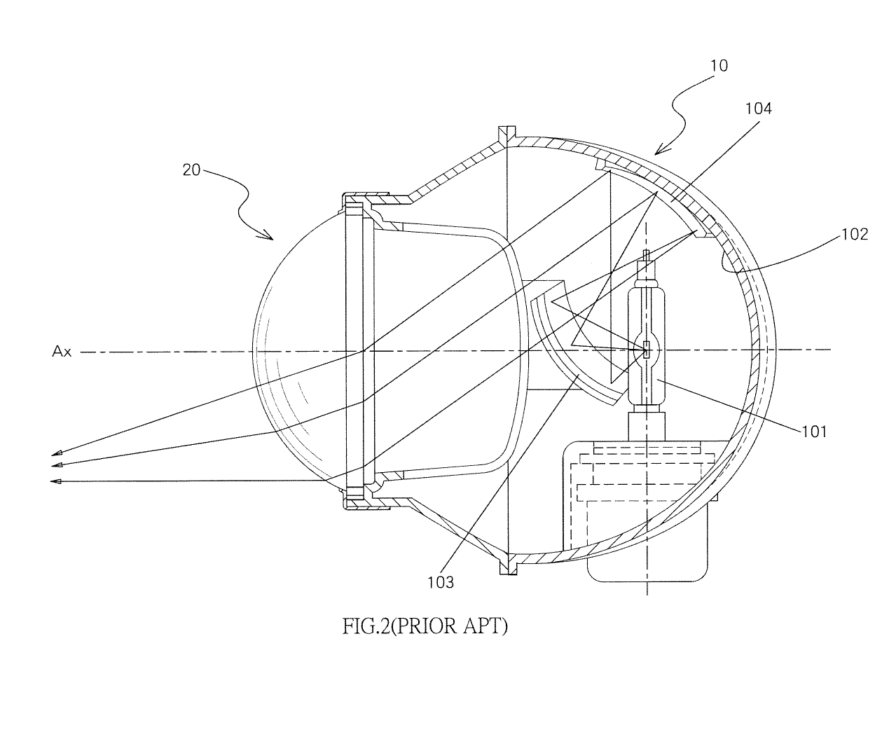

FIG. 3 is an exploded view to show the headlight of the present invention;

FIG. 4 is a perspective view to show the headlight of the present invention;

FIG. 5 shows the tracks of the light beams of the headlight of the present invention, and

FIG. 6 shows the tracks of the light beams of another embodiment of the headlight of the present invention.

### DETAILED DESCRIPTION OF THE PREFERRED EMBODIMENT

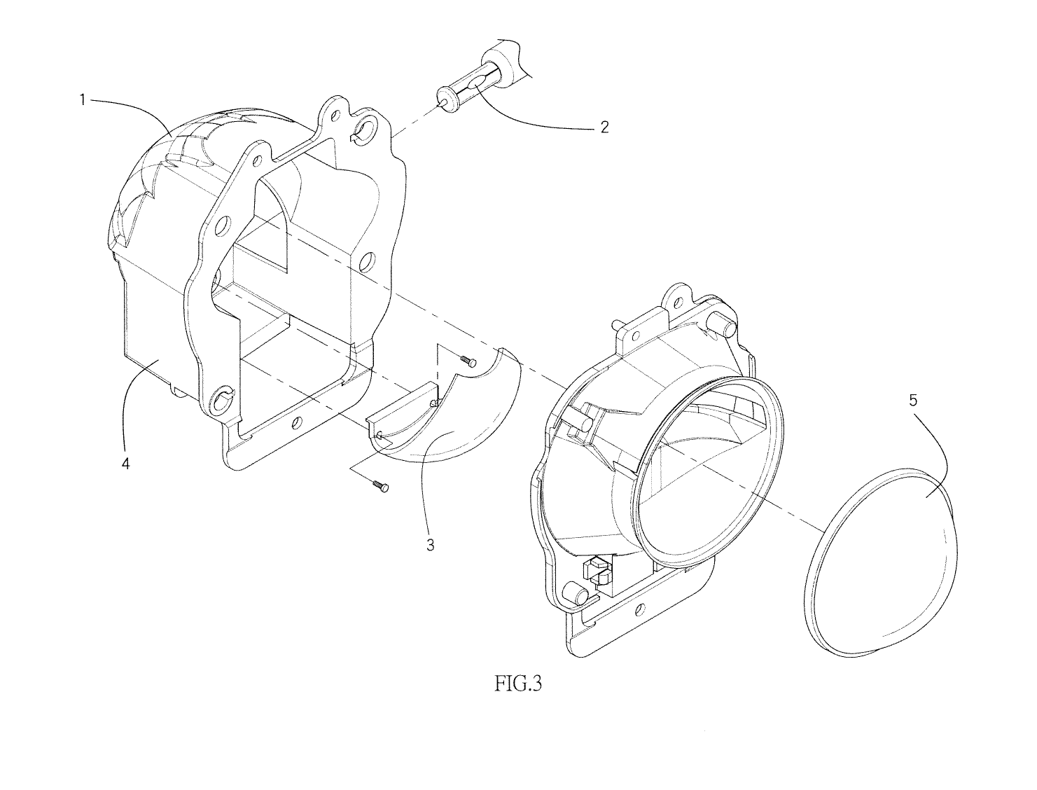

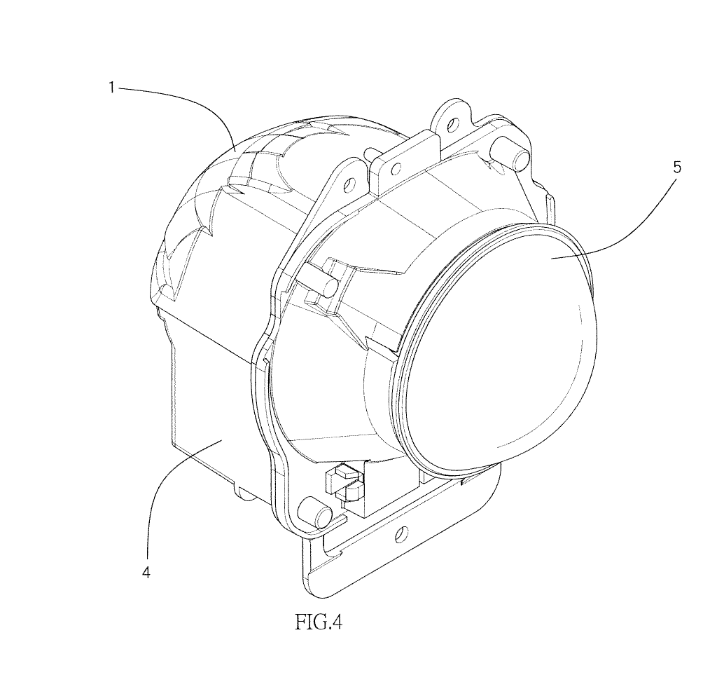

Referring to FIGS. 3 to 5, the first embodiment of the headlight of the present invention comprises a main reflective member 1 having an oval reflective surface 11 which has a first focal point F₁ and a second focal point F₂. A light source 2 is located at the first focal point F₁ of the main reflective member 1, and the light source 2 is a filament.

An additional reflector 3 is located on one side of the main reflective member 1 wherein the light source 2 is located between the main reflective member 1 and the additional reflector 3. The additional reflector 3 has a curved reflective surface 31 which is a non-spherical surface has a third focal point F₃ which is located close to the first focal point F₁.

A base 4 which has the main reflective member 1 formed thereto and the light source 2 is located in the base 4. A lens 5 is connected to the base 4 and located on the optical axis Aₓ of the light source 2. A shade 6 is located between the main reflective member 1 and the lens 5.

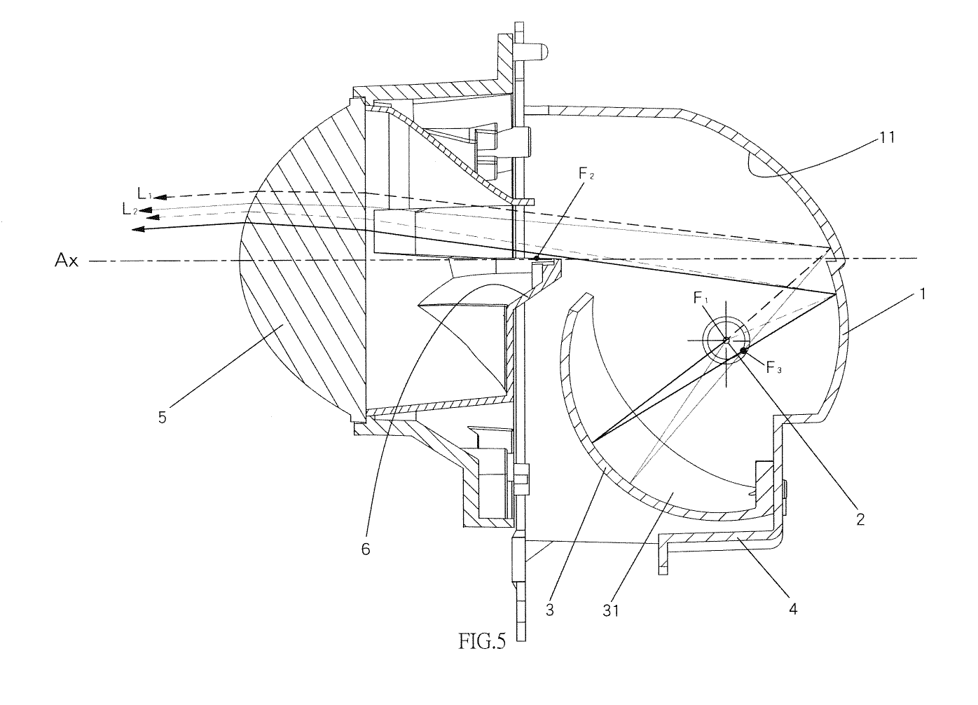

As shown in FIG. 5, when the light source 2 generates the light beams, the tracks L₁ (dotted lines) of one portion of the light beams extend toward the main reflective member 1, i.e., the rear side of the light source 2, and the light beams are directly reflected by the main reflective member 1 and then pass through the lens 5. This generates the required luminous distribution pattern that meets the regulations. The tracks L₂ (solid lines) of the other portion of the light beams extend toward the lens 5, i.e., the front side of the light source 2, and the light beams are reflected by the additional reflector 3 and pass through the third focal point F₃ and then reflected by the main reflective member 1. Because the third focal point F₃ is located close to the first focal point F₁ so that the light beams that are reflected by the addition reflector 3 are focused at a position close to the light source 2. The tracks L₂ are similar and close to the tracks L₁ that are directly reflected by the main reflective member 1, such that the tracks L₂ and the pattern meet the regulations. It is noted that the third focal point F₃ is located close to the first focal point F₁ so as to prevent that the light beams reflected by the additional reflector 3 directly move to the light source 2 and fail to perform the desired functions. The third focal point F₃ is located within an area of four times of the radius of the light source 2. In order to have better tracks L₂, the third focal point F₃ is located within an area of two times of the radius of the light source 2. The preferable position of the third focal point F₃ is to be located on the periphery of the radius of the light source 2.

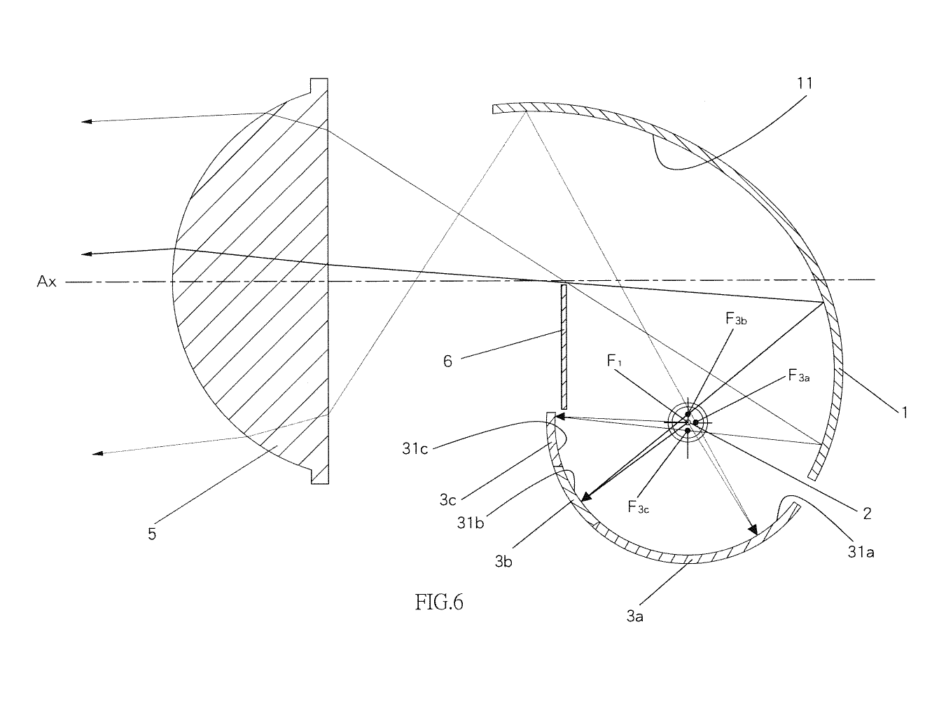

FIG. 6 shows the second embodiment of the present invention, the difference from the first embodiment is that the additional reflectors 3a, 3b and 3c are multiple and have three third focal points F₃ₐ, F_{3b}, F_{3c}. The curved reflective surfaces 31a, 31b, 31c are spherical surfaces. When the light source 2 is activated, the light beams are reflected by the additional reflector 3a and pass through the third focal point F₃ₐ. Similarly, the light beams reflected by the additional reflectors 3b, 3c pass through the third focal points F_{3b}, F_{3c}, and are reflected by the main reflective member 1 and then pass through the lens 5. This also generates the required luminous distribution pattern that meets the regulations. It is obvious that the three third focal points F₃ₐ, F_{3b}, F_{3c} are located close to the first focal point F₁. As mentioned in the first embodiment, the tracks of the light beams that are reflected from the additional reflectors 3a, 3b, 3_{c} are similar and close to the tracks that are directly reflected by the main reflective member 1. The present invention does not limit the main reflective member 1 is integrally formed with the additional reflectors 3a, 3b, 3c or not.

The light source is inserted to the base from one side so that the installation direction of the light source is perpendicular to the optical axis of the light source, and this shortens the depth of the base of the headlight. The light source is located between the main reflective member and the additional reflector to achieve the desired features.

The time required for designing the optical structure of the present invention is reduced. The third focal point of the additional reflector is located close to the first focal point of the main reflective member so that the light beams reflected by the additional reflector are focused at the position close to the light source. Therefore, the present invention does not need the first and second additional reflectors as used in the conventional headlight, and does not have to deal with the problems caused by the difference of the tracks of the light beams reflected by the first and second additional reflectors. The present invention only needs the additional reflector and can have the desired luminous distribution pattern.

The present invention utilizes the main reflective member and the additional reflector to let the light beams reflected by the additional reflector to pass the third focal point, and then reflected by the main reflective member and pass through the lens. The tracks from the additional reflector are similar and close to the tracks that are directly reflected by the main reflective member, such that the tracks and the luminous distribution pattern meet the regulations. The present invention also significantly increases the brightness.

While we have shown and described the embodiment in accordance with the present invention, it should be clear to those skilled in the art that further embodiments may be made without departing from the scope of the present invention.

What is claimed is:

1. A headlight comprising:
a main reflective member having an oval reflective surface which has a first focal point and a second focal point;
a light source located at the first focal point of the main reflective member, and
at least one additional reflector located on one side of the main reflective member, the light source located between the main reflective member and the additional reflector, the at least one additional reflector having a curved reflective surface which has a third focal point located close to the first focal point.

2. The headlight as claimed in claim 1, wherein the third focal point is located within an area of four times of a radius of the light source.

3. The headlight as claimed in claim 1, wherein the third focal point is located within an area of two times of a radius of the light source.

4. The headlight as claimed in claim 1, wherein the third focal point is located on a periphery of a radius of the light source.

5. The headlight as claimed in claim 1, wherein the curved reflective surface is a spherical surface.

6. The headlight as claimed in claim 1, wherein the curved reflective surface is a non-spherical surface.

7. The headlight as claimed in claim 1 further comprising a base which accommodates the main reflective member and the light source, a lens is connected to the base and located on an optical axis of the light source.

8. The headlight as claimed in claim 7, wherein a shade is located between the main reflective member and the lens.
